(19) United States
(12) Patent Application Publication
(10) Pub. No.: US 2006/0153190 A1
(43) Pub. Date: Jul. 13, 2006

(54) System-on-a-chip using CDMA bus and data transmission method therefor

(75) Inventors: Eui-seok Kim, Suwon-si (KR); Beom-hak Lee, Seoul (KR); Sang-woo Rhim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/327,349

(22) Filed: Jan. 9, 2006

(30) Foreign Application Priority Data
Jan. 11, 2005 (KR) 10-2005-0002420

(51) Int. Cl. H04L 12/56

(52) U.S. Cl. 370/389

(57) ABSTRACT

System-on-a-chip using a CDMA bus and data transmission method therefor. The system-on-a-chip has plural IP-cores dividing into at least one group according to a predetermined reference; and at least one arbiter connected to the IP-cores belonging to the at least one group, receiving a unique ID of a reception-side IP-core receiving data from a transmission-side IP-core sending the data, and sending the transmission-side IP-core a code word assigned to the reception-side IP-core corresponding to the received unique ID, thereby reducing the length of the code word assigned to the IP-cores.

### CROSS-REFERENCE TO RELATED APPLICATION

This application claims benefit under 35 U.S.C. § 119 from Korean Patent Application 2005-2420 filed on Jan. 11, 2005 in Korean Intellectual Property Office, the entire content of which is incorporated herein by reference.

### BACKGROUND OF THE INVENTION

1. Field of the Invention

The present invention relates to system-on-a-chip (SoC) using a code-division multiple access (CDMA) bus and data transmission method therefor, and more particularly to system-on-a-chip using a CDMA bus and data transmission method therefor wherein intellectual property (IP)-cores connected to the CDMA bus are grouped according to a certain reference so that the length of code words assigned to the IP-cores can be reduced.

2. Description of Related Art

It is necessary to use lots of semiconductor chips such as microprocessors, network chips, memories, and so on, in various digital information devices such as hand-held phones, personal digital assistants (PDA), digital TVs, smart phones, and so on, for smooth internet access and/or computing functions.

Further, it is a trend that these information devices are becoming gradually more complicated and diverse in their functions, and, since such devices are more likely to converge into one, more chips are needed in each information device.

The system-on-a-chip (SoC) has emerged as a technology for putting semiconductor components as well as all individual components into one chip by integrating various components into one chip. Thus, a system-on-a-chip holds all of the necessary hardware and electronic circuitry for a complete system.

The SoC is built with operational devices, I/O circuits, logic circuits, memories, and so on. The compact and highly-integrated SoC features high performance and low power consumption, so it is expected to be used for various information devices. IP-cores are used for rapid semiconductor chip designs. The IP-cores refer to designed blocks developed for applications to corresponding chips.

Lots of technologies have been studied for implementing SoCs, and, in particular, there have emerged methods for connecting plural IP-cores built in a chip as very important issues. A method using a bus structure can be taken as an example for connecting plural IP-cores.

The on-chip bus for the SoC does not allow multiple connections due to its characteristics, but the recently developed CDMA bus allows the multiple connections. To do this, the CDMA bus uses an orthogonal code, for example, a Walsh code.

An IP-core connected to the CDMA bus is assigned an orthogonal code having a predetermined length, and the length of a code word is linearly increased depending on the number of IP-cores using the bus. For example, if the number, n, of IP-cores connected to the CDMA bus can be expressed as n=2^{m}<n<2^{m+1}, the length of the code becomes 2^{m+1}.

FIG. 1 is a view for showing a conventional CDMA bus structure.

FIG. 1 exemplarily shows eight IP-cores A to H connected to the CDMA bus 10. The eight IP-cores A to H are assigned a different 8-bit code word. As shown in FIG. 1, “A” is assigned a code word of “00000000”, “B” “01010101”, “C” “00110011”, “D” “01100110”, “E” “00001111”, “F” “01011010”, “G” “00111100”, and “H” “01101001”.

If the length of the code words of the IP-cores A to H is increased, the area for hardware components implemented in parallel structure for the CDMA bus is increased, the performance of hardware components implemented in sequential structure for the CDMA bus is decreased, and the power consumption of the CDMA bus is increased. For example, if the modulator is implemented in parallel structure for the CDMA bus, there exists a two-times difference between a n-bit code word and a 2n-bit code word in terms of a required hardware area.

The CDMA bus enables multiple connections to a bus which is a sharing resource but not widely used due to a problem occurring as the length of code words depending on the number of IP-cores A to H is increased as stated above.

Accordingly, a technology guaranteeing the use of code words of a proper length is required to follow a trend increasing the number of IP-cores integrated on a single chip, taking advantages that the CDMA bus per se has.

### BRIEF SUMMARY

An aspect of the present invention has been developed in order to solve the above drawbacks and other problems associated with the conventional arrangement. An aspect of the present invention also provides system-on-a-chip using the CDMA bus and data transmission method therefor for dividing plural IP-cores connected to the CDMA bus into groups according to a predetermined reference, assigning a code ward to the divided groups, thereby selecting an optimized code word length.

According to an aspect of the present invention, there is provided a system-on-a-chip (SoC) using a CDMA bus, including: plural intellectual Property (IP)-cores dividing into at least one group by a predetermined reference; and at least one arbiter connected to the IP-cores belonging to the at least one group, receiving a unique ID of a reception-side IP-core receiving data from a transmission-side IP-core sending the data, and sending the transmission-side IP-core a code word assigned to the reception-side IP-core corresponding to the received unique ID.

The predetermined reference may be a length of a code word assigned to the IP-cores, and the maximum number of the IP-cores belonging to one group is determined according to the length of the code word.

A different code word may be assigned to IP-cores belonging to one group of the divided groups, and an identical code word is assigned to IP-cores belonging to different groups.

The SoC further may include bridges which is connected to the at last one arbiter when the number of the at least one arbiter is more than two. Further, the bridges may each include plural demodulators for demodulating packets inputted from the arbiters; a routing analyzer for routing the demodulated packets; plural modulators for modulating the demodulated packets.

If the arbiters do not retain, in a group to which the arbiters belong, unique IDs of reception-side IP-cores received from transmission-side IP-cores, the arbiters may send the transmission-side IP-cores a code word assigned to the bridge.

The transmission-side IP-cores may modulate data by using the received code word assigned to the bridge, and send the modulated data to the bridge. The bridge may demodulate the received data by using its own code word, and sends the demodulated data to the reception-side IP-cores based on the unique IDs corresponding to the reception-side IP-cores.

Further, an identical code word may be assigned to IP-cores in the same group, and a different code word is assigned to IP-cores belonging to different groups, respectively.

The arbiter may be a single arbiter, and the single arbiter sends data to the reception-side IP-cores by using the unique IDs of the reception-side IP-cores received from the transmission-side IP-cores.

According to another aspect of the present invention, there is provided a system-on-a-chip using a CDMA bus and having plural IP-cores receiving and sending data by using the CDMA bus, wherein the plural IP-cores are grouped, the number of IP-cores accommodated in a group is determined by a length of a code word, a different code word is assigned to IP-cores belonging to each of the divided groups, and the same code word is assigned to IP-cores belonging to different groups, respectively.

According to another aspect of the present invention, there is provided a system-on-a-chip using a CDMA bus and having plural IP-cores receiving and sending data by using the CDMA bus, wherein the plural IP-cores are grouped, a number of IP-cores accommodated in a group is determined by a length of a code word, the same code word is assigned to IP-cores belonging to each of the divided groups, and a different code word is assigned to IP-cores belonging to different groups, respectively.

According to another aspect of the present invention, there is provided a data transmission method for a system-on-a-chip having a transmission stage for modulating data and a reception stage for demodulating the data sent from the transmission stage, including: creating data by the transmission stage, including an unique ID of the reception stage; receiving by the transmission stage a code word assigned to the reception stage; modulating the data by the transmission stage by using the received code word, and sending the modulated data to the reception stage; and demodulating the received data by the reception stage.

The system-on-a-chip may include plural IP-cores divided into plural groups according to a predetermined reference; plural arbiters connected to the IP-cores belonging to the groups; and a bridge for connecting the plural arbiters.

A different code word may be assigned to IP-cores belonging to each of the groups, and the same code word is assigned to IP-cores belonging to different groups. Further, the transmission stage may be any of the plural IP-cores, and the reception stage is either the plural IP-cores or the bridge.

The system-on-a-chip may include plural IP-cores divided into plural groups according to a predetermined reference; and an arbiter connecting the IP-cores.

An identical code word may be assigned to IP-cores in the same group, and a different code word is assigned to IP-cores belonging to different groups, respectively. Further, the transmission stage and the reception stage may be any of the plural IP-cores.

Additional and/or other aspects and advantages of the present invention will be set forth in part in the description which follows and, in part, will be obvious from the description, or may be learned by practice of the invention.

The data transmission method for a system-on-a-chip further comprises determining whether the transmission stage and the reception stage are in the same group.

The data transmission method for a system-on-a-chip further comprises receiving a code word of a bridge from the arbiter, modulating the data using the code word of the bridge and sending the modulated data and setting the bridge as a new transmission state.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a view for showing a conventional CDMA bus structure;

FIG. 2 is a view for explaining a system-on-a-chip using a divided CDMA bus according to an embodiment of the present invention;

FIG. 3 is a view for explaining a system-on-a-chip using a divided CDMA bus according to an embodiment of the present invention;

FIG. 4 is a block diagram for showing a bridge of FIG. 3;

FIG. 5 is a view for explaining a system-on-a-chip using a single CDMA bus according to an embodiment of the present invention;

FIG. 6 is a flowchart for explaining a data transmission method for a system-on-a-chip according to an embodiment of the present invention; and

FIG. 7 is a flowchart for explaining a data transmission method for a system-on-a-chip according to an embodiment of the present invention.

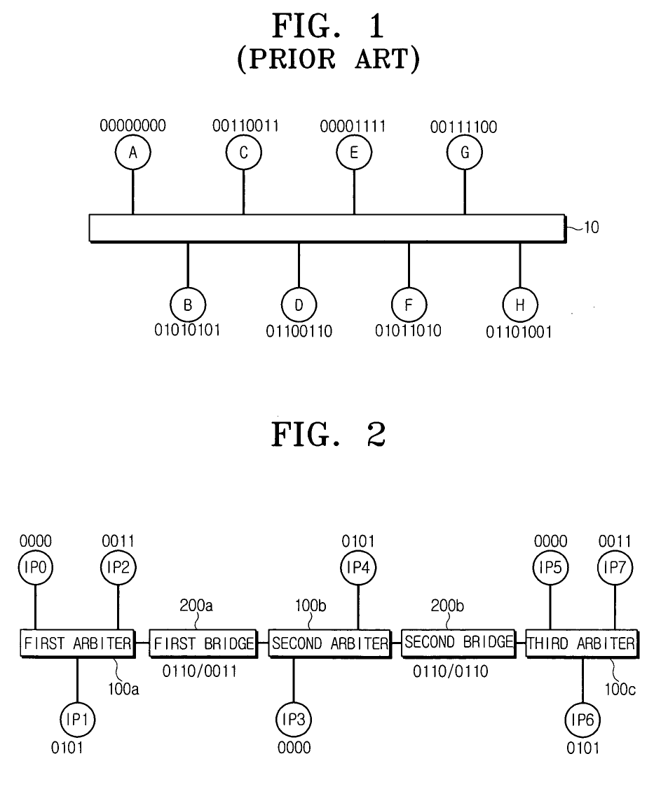

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

First, a system-on-a-chip using a CDMA bus according to an embodiment of the present invention comprises a transmission stage for modulating data and a receiving stage for demodulating the transmitted data. The transmission and receiving stages can be an IP-core, respectively.

The plural IP-cores are connected to the CDMA bus and are grouped according to a predetermined reference. The predetermined reference is a length of a code word assigned to the IP-cores, and the length of the code word determines the maximum number of IP-cores belonging to one group.

In the present embodiment, a system has a CDMA bus distributed into plural sub-CDMA buses depending on the number of IP-cores, which is referred to as a distributed CDMA system. Further, a system has IP-cores divided into groups without the divided CDMA bus, which is referred to as a single CDMA system.

FIG. 2 is a view for explaining a system-on-a-chip using a distributed CDMA bus according to an embodiment of the present invention.

The system-on-a-chip using the distributed CDMA bus according to the present embodiment includes plural IP-cores IP0 to IP7, plural arbiters, and plural bridges.

The IP-cores IP0 to IP7 are divided into at least one group according to a predetermined reference. In the present embodiment, no one group includes more than four IP-cores connected to one sub-CDMA bus, so that the length of a code word is limited to 4 bits.

The IP-cores each have a unique identifier (ID), and are assigned a code word to be used for data modulations and demodulations. The IP-cores belonging to the same group, for example, IP0 to IP2, IP3 to IP4, and IP5 to IP7, are each assigned a different code word, respectively. However, the IP-cores belonging to different groups can be assigned an identical code word. As shown in FIG. 2, IP-cores IP0, IP3, and IP5 are assigned “0000”, IP-cores IP1, IP4, and IP6 are assigned “0101”, and IP-cores IP2 and IP7 are assigned “0011”.

For the purposes of description on the present embodiment, the IP-cores IP0 to IP7 are divided into transmission-side IP-cores for sending data and reception-side IP-cores for receiving data. The transmission-side IP-cores modulate data by using a predetermined code word. The reception-side IP-cores receive data sent from the transmission-side IP-cores, and modulate the data by using a code word of their own.

The arbiters are connected to the IP-cores IP0 to IP7 divided into groups. That is, one arbiter is connected to one sub-CDMA bus. FIG. 2 shows first, second, and third arbiters 100a, 100b, and 100c connected to three sub-CDMA buses, respectively.

The first to third arbiters 100a to 100c receive an unique ID of a reception-side IP-core to receive data from a transmission-side IP-core, and send to the transmission-side IP-core an code word assigned to the reception-side IP-core corresponding to the received unique ID.

As shown in FIG. 2, in the present embodiment, the first arbiter 100a is connected to the IP-cores IP0 to IP2, the second arbiter 100b is connected to the IP-cores IP3 and IP4, and the third arbiter 100c is connected to the IP-cores IP5 to IP7.

Therefore, the IP-cores IP0 to IP2 request the first arbiter for a code word of a reception-side IP-core, the IP-cores IP3 and IP4 request the second arbiter 100b for a code word of a reception-side IP-core, and the IP-cores IP5 to IP7 request the third arbiter 100c for a code word of a reception-side IP-core.

In order to send the code word of the reception-side IP-core requested by the transmission-side IP-core, the first to third arbiters 100a to 100c retain code words assigned to the IP-cores connected to the same sub-CDMA bus.

If a transmission-side IP-core requests the first to third arbiters 100a to 100c for a code word of a reception-side IP-core, the first to third arbiters 100a to 100c send the corresponding code word out of their retaining code words, but, if the first to third arbiters 100a to 100c do not retain the corresponding code word, the first to third arbiters 100a to 100c send the transmission-side IP-core a code word of a bridge which will be later described.

Table 1 exemplarily shows code words that the first to third arbiters 100a to 100c each retain.

TABLE 1

| | Unique | Code | |
|---|---|---|---|
| arbiters | IDs | words | Remarks |
| First arbiter | IP0 | 0000 | IP-core |
| | IP1 | 0101 | IP-core |
| | IP2 | 0011 | IP-core |
| | B1 | 0110 | First bridge |
| Second arbiter | IP3 | 0000 | IP-core |
| | IP4 | 0101 | IP-core |
| | B1 | 0011 | IP-core |
| | B2 | 0110 | Second bridge |
| Third arbiter | IP5 | 0000 | IP-core |
| | IP6 | 0101 | IP-core |
| | IP7 | 0011 | IP-core |
| | B2 | 0110 | IP-core |

If there exist plural arbiters, that is, if the CDMA bus is distributed into plural sub-CDMA buses, the bridge connects the plural arbiters. FIG. 2 shows a first bridge 200a connecting the first and second arbiters 100a and 100b and a second bridge 200b connecting the second arbiter 100b and the third arbiter 100c, for example.

The first and second bridges 200a and 200b are assigned a unique ID and a code word, respectively, as in the IP-cores IP0 to IP7. As shown in Table 1, the first bridge 200a is assigned “0110” used for the first arbiter 100a and “0011” used for the second arbiter 100b, and the second bridge 200b is assigned “0110” used for the second and third arbiters 100b and 100c. As above, the codes assigned to a bridge can be different or the same depending on the arbiters connected to the bridge.

The first and second bridges 200a and 200b connect arbiters (or, sub-CDMA buses), but, if the first to third arbiters 100a to 100c do not retain a code word of a reception-side IP-core requested, the first to third arbiters have the same function as the reception-side IP-core.

For example, if the IP-core IP0 tends to send data to the IP-core IP3, the first arbiter 100a sends to the IP-core IP0 a code word “0110” assigned to the first bridge 200a since the IP-cores IP0 and IP3 are not connected to the same arbiter. The IP-core IP0 modulates data by using “0110”, and sends the modulated data to the first bridge 200a. Next, the first arbiter 100a forms a new transmission stage.

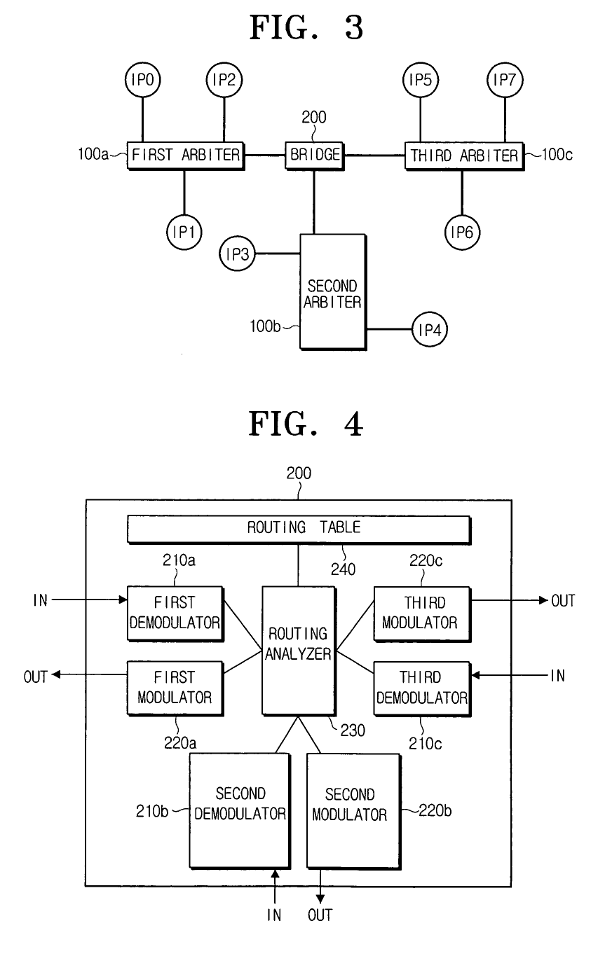

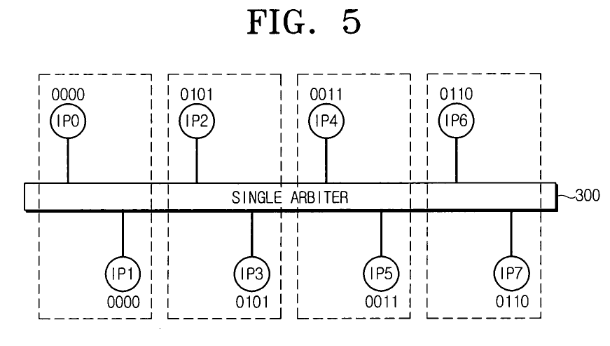

FIG. 3 is a view for explaining a system-on-a-chip using a distributed CDMA bus according to another embodiment of the present invention, and FIG. 4 is a block diagram for showing a bridge of FIG. 3. In FIG. 2, the distributed sub-CDMA buses are connected one another in series, but, in FIG. 3, the distributed sub-CDMA buses are connected one another in the form of a star, of which further description will be made.

In FIGS. 3 and 4, if the first arbiter 100a, second arbiter 100b, and third arbiter 100c are arranged in the form of a star, the system-on-a-chip can be implemented with one bridge 200 connecting all the first arbiter 100a, second arbiter 100b, and third arbiter 100c.

The bridge 200 has to set a path along which input data is outputted. To do this, the bridge 200 is provided with a routing analyzer 230. FIG. 4 shows a structure of the bridge 200.

The bridge 200 has plural demodulators, plural modulators, routing analyzer 230, and a routing table 240.

The plural demodulators are provided to match with arbiters connected to the bridge 200, and receive and demodulate data inputted from the arbiters. The first arbiter 100a is connected to a first demodulator 210a, the second arbiter 100b to a second demodulator 210b, and the third arbiter 100c to a third demodulator 210c.

The plural modulators are provided to match with the arbiters connected to the bridge 200, as in the demodulators, and modulate by using a code word of their own and output data demodulated by the demodulators. The first arbiter 100a is connected to a first modulator 220a, the second arbiter 100b is connected to a second modulator 220b, and the third arbiter 100c is connected to a third modulator 220c.

The routing analyzer 230 routes data demodulated by the first to third demodulators 210a to 210c. As shown in FIG. 2, if the sub-CDMA buses are connected in a series structure, separate routings are not necessary since inputs match to outputs, respectively. However, as shown in FIG. 3, if the sub-CDMA buses are connected in the form of a star and three or more arbiters are connected to one bridge, the routing analyzer 230 has to decide an output path.

The routing table 240 stores paths of data transmissions through an unique ID of a reception-side IP-core included in data modulated by the first to third modulators 220a to 220c, the routing analyzer 230 refers to the routing table 240.

FIG. 5 is a view for explaining a system-on-a-chip using a single CDMA bus according to an embodiment of the present invention.

The system-on-a-chip using a single CDMA bus according to an embodiment of the present invention has plural IP-cores IP0 to IP7 and a single arbiter 300.

The present embodiment assigns the same code word to IP-cores belonging to one of groups of the plural IP-cores, and assigns a different code word to IP-cores belonging to different groups.

As shown in FIG. 5, the IP-cores are assigned a 4-bit code word, respectively, that is, the IP-cores IP0 and IP1 are assigned “0000”, the IP-cores IP2 and IP3 “0101”, the IP-cores IP4 and IP5 “0011”, and the IP-cores IP6 and IP7 “0110”. The code word assigned to each of the IP-cores IP0 to IP7 respectively are not limited to the above, but, any code word can be accepted if not overlapped when assigned group by group.

The single arbiter 300 sends a code word of a reception-side IP-core to a transmission-side IP-core when the transmission-side IP-core requests the reception-side IP-core for the code word. If the single arbiter 300 receives data from transmission-side IP-core, the arbiter 300 extracts unique IDs of the reception-side IP-cores from the data and sends a unique ID to a right reception-side IP-core, since the transmission-side IP-core receives the same code word from the plural reception-side IP-cores.

Further, if the single arbiter 300 is requested by plural transmission-side IP-cores for data transmissions to plural reception-side IP-cores assigned the same code word, the arbiter 300 decides priority by using a predetermined arbitration scheme in order to avoid collisions occurring due to the same code word occupied by the plural reception-side IP-cores.

The single arbiter 300 also retains unique IDs and code words of the IP-cores IP0 to IP7 connected to the CDMA bus, like the first to third arbiters 100a to 100c of FIG. 2, which are listed in Table 2.

TABLE 2

| Arbiters | Unique IDs | Code words |
|---|---|---|
| Single arbiters | IP0 | 0000 |
| | IP1 | 0000 |
| | IP2 | 0101 |
| | IP3 | 0101 |
| | IP4 | 0011 |
| | IP5 | 0011 |
| | IP6 | 0110 |
| | IP7 | 0110 |

As stated above, the system-on-a-chip shown in FIG. 2 to FIG. 5 has eight IP-cores IP0 to IP7, so the IP-cores IP0 to IP7 are assigned a 8-bit code word, respectively, but the present embodiment divides the IP-cores IP0 to IP7 into groups, so a 4-bit code word can be assigned.

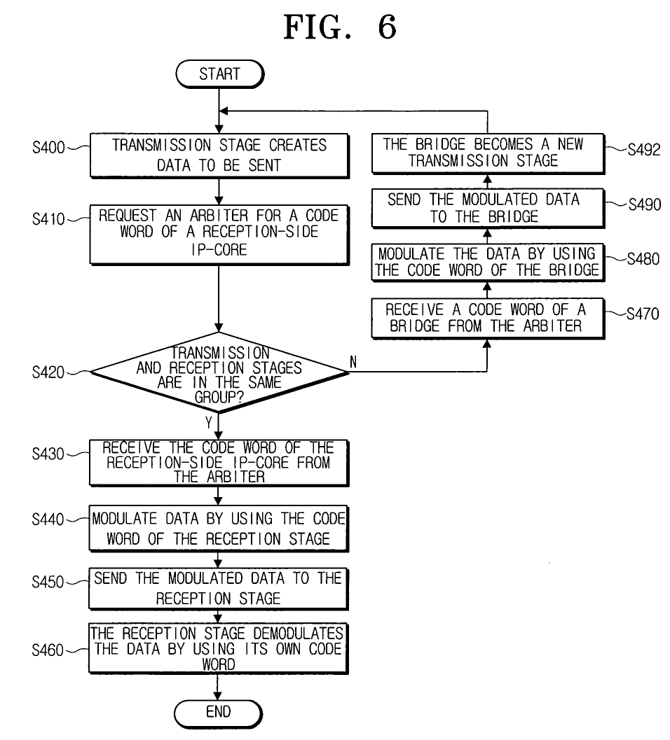

FIG. 6 is a flowchart for explaining a data transmission method for system-on-a-chip according to an embodiment of the present invention.

Referring to FIGS. 2 and 6, a transmission-side IP-core at a transmission stage creates data to be sent to a reception-side IP-core, including a unique ID of the reception-side IP-core at a reception stage (S400), sends the unique ID of the reception-side IP-core to the arbiter connected to the same sub-CDMA bus, and requests a code word of the reception-side IP-core (S410). If the transmission-side IP-core is IP0, the IP0 requests the first arbiter 100a for the code word of the reception-side IP-core.

The first arbiter 100a requested by the transmission-side IP-core IP0 for the code word decides whether the transmission-side IP-core IP0 and the reception-side IP-core belong to the same group. That is, the arbiter decides whether to retain the unique ID and code word of the reception-side IP-core by deciding whether the transmission-side IP-core IP0 and the reception-side IP-core belong to the same group (S420).

If it is decided that the transmission-side IP-core IP0 and the reception-side IP-core belong to the same group in the operation S420, the first arbiter 100a sends the transmission-side IP-core the code word corresponding to the unique ID of the reception-side IP-core received from the transmission-side IP-core IP0 (S430). For example, if the transmission-side IP-core is IP0 and the reception-side IP-core is IP1, the first arbiter 100a sends “0101” to IP0.

Next, the transmission-side IP-core IP0 modulates data by using the code word of “0101” received from the arbiter (S440), and sends the modulated data to the reception-side IP-core IP1 (S450).

The reception-side IP-core IP1 received with data sent from the transmission-side IP-core IP0 demodulates the received data by using its own code word of “0101” (S460).

If it is not decided that the transmission-side IP-core IP0 and the reception-side IP-core belong to the same group in the operation S420, the first arbiter 100a sends the code word of the first bridge 200a to the transmission-side IP-core (S470). For example, if the transmission-side IP-core is IP0 and the reception-side IP-core is IP3, the first arbiter 100a sends the code word of “0110” of the first bridge 200a to the transmission-side IP-core IP0.

The transmission-side IP-core IP0 modulates data to be sent, using the received code word of “0110” (S480), and sends the modulated data to the first bridge 200a (S490).

Next, the first bridge 200a received with the data from the transmission-side IP-core IP0 becomes a new transmission stage (S492).

That is, the first bridge 200a demodulates the data received from the transmission-side IP-core IP0, using its own code word of “0110”, checks the unique ID of the reception-side IP-core IP3 from the demodulated data, and creates new data.

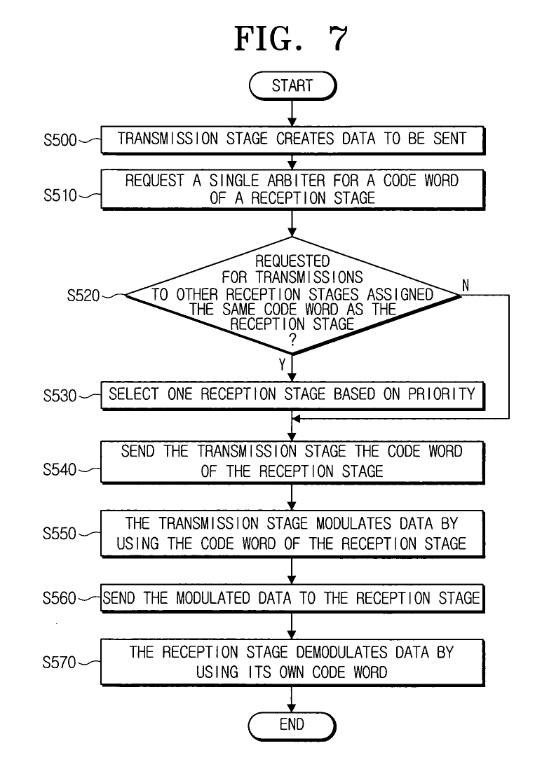

FIG. 7 is a flowchart for explaining a data transmission method for a system-on-a-chip according to another embodiment of the present invention.

Referring to FIGS. 5 and 7, a transmission-side IP-core creates data including a unique ID of a reception-side IP-core (S500), sends the single arbiter 300 the unique ID of the reception-side IP-core, and requests the arbiter 300 for the code word of the reception-side IP-core (S510). For example, it is assumed that the transmission-side IP-core is IP0 and the reception-side IP-core is IP3.

The single arbiter 300 requested by the transmission-side IP-core IP0 decides whether another transmission-side IP-core, for example, IP4, requests transmissions to a different reception-side IP-core IP2 assigned the same code word as that of the reception-side IP-core IP3 (S520).

In the operation S520, if the single arbiter 300 is requested by the transmission-side IP-core IP0 for transmissions to the reception-side IP-core IP3 and by the transmission-side IP-core IP4 for transmissions to the reception-side IP-core IP2, the single arbiter 300 selects the transmissions to the reception-side IP-core IP3 from the transmission-side IP-core IP0 (S530).

If the single arbiter 300 is not requested for transmissions to plural reception-side IP-core having the same code word in the operation S520 or selects the transmissions in the operation S530, the single arbiter 300 sends the code word, “0101”, of the reception-side IP-core IP3 to the transmission-side IP-core IP0 (S540).

The transmission-side IP-core IP0 modulates data to be sent, using the received code word of “0101” of the reception-side IP-core IP3 (S550), and sends the modulated data to the reception-side IP-core IP3 (S560).

Next, the reception-side IP-core IP3 demodulates the received data from the transmission-side IP-core IP0 by using its own code word (S570).

A system-on-a-chip using the CDMA bus and data transmission method therefor according to the above-described embodiments of the present invention divide into groups IP-cores connected to the CDMA bus according to a predetermined reference, and assign a code word group by group, so as to reduce the length of the code word determined depending on the number of the IP-cores.

Accordingly, the above-described embodiments of the present invention enable an optimized length of code words to be selected, so as to reduce the area of hardware components implemented in parallel with the CDMA bus, enhance the performance of the hardware components implemented in sequence with the CDMA bus, and reduce power consumption caused by the CDMA bus.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A system-on-a-chip (SoC) using a code-division multiple access (CDMA) bus, comprising:
plural intellectual Property (IP)-cores dividing into at least one group by a predetermined reference; and
at least one arbiter connected to the IP-cores belonging to the at least one group, receiving a unique ID of a reception-side IP-core receiving data from a transmission-side IP-core sending the data, and sending the transmission-side IP-core a code word assigned to the reception-side IP-core corresponding to the received unique ID.

2. The SoC as claimed in claim 1, wherein the predetermined reference is a length of a code word assigned to the IP-cores, and the maximum number of the IP-cores belonging to a group is determined according to the length of the code word.

3. The SoC as claimed in claim 1, wherein, when there are plural groups of IP-cores, a different code word is assigned to IP-cores in the same group, and an identical code word can be assigned to ones of IP-cores belonging to different groups.

4. The SoC as claimed in claim 3, wherein the at least one arbiter is more than two arbiters, and the SoC further comprises bridges which are connected to each arbiter.

5. The SoC claimed in claim 4, wherein the bridges each include:
plural demodulators demodulating packets input from the arbiters;
a routing analyzer routing the demodulated packets;
plural modulators modulating the demodulated packets.

6. The SoC claimed in claim 4, wherein, when the arbiters do not retain, in a group to which the arbiters belong, unique IDs of reception-side IP-cores received from transmission-side IP-cores, the arbiters send the transmission-side IP-cores a code word assigned to the bridge.

7. The SoC claimed in claim 6, wherein the transmission-side IP-cores modulate data using the received code word assigned to the bridge, and send the modulated data to the bridge.

8. The SoC claimed in claim 7, wherein the bridge demodulates the received data using its own code word, and sends the demodulated data to the reception-side IP-cores based on the unique IDs corresponding to the reception-side IP-cores.

9. The SoC claimed in claim 1, wherein, when there are plural groups of IP-cores, an identical code word is assigned to IP-cores in the same group, and a different code word is assigned to ones of IP-cores belonging to different groups.

10. The SoC as claimed in claim 9, wherein the at least one arbiter is a single arbiter, and the single arbiter sends data to the reception-side IP-cores by using the unique IDs of the reception-side IP-cores received from the transmission-side IP-cores.

11. A system-on-a-chip using a code-division multiple access (CDMA) bus and having plural intellectual property (IP)-cores receiving and sending data using the CDMA bus, wherein the plural IP-cores are grouped, a number of IP-cores in a group is determined by a length of a code word, a different code word is assigned to IP-cores in the same group, and the same code word is assigned to ones of IP-cores belonging to different groups.

12. A system-on-a-chip using a code-division multiple access (CDMA) bus and having plural intellectual property (IP)-cores receiving and sending data using the CDMA bus, wherein the plural IP-cores are grouped, a number of IP-cores in a group is determined by a length of a code word, the same code word is assigned to IP-cores in the same group, and a different code word is assigned to ones of IP-cores belonging to different groups.

13. A data transmission method for a system-on-a-chip having a transmission stage for modulating data and a reception stage for demodulating the data sent from the transmission stage, comprising:
creating data via the transmission stage, including an unique ID of the reception stage;
receiving via the transmission stage a code word assigned to the reception stage;
modulating the data via the transmission stage by using the received code word, and sending the modulated data to the reception stage; and
demodulating the received data via the reception stage.

14. The method as claimed in claim 13, wherein the system-on-a-chip includes:
plural IP-cores divided into plural groups according to a predetermined reference;
plural arbiters connected to the IP-cores belonging to the groups; and
a bridge for connecting the plural arbiters.

15. The method as claimed in claim 14, wherein a different code word is assigned to IP-cores belonging to each of the groups, and the same code word is assigned to ones of IP-cores belonging to different groups.

16. The method as claimed in claim 14, wherein the transmission stage is any of the plural IP-cores.

17. The method as claimed in claim 14, wherein the reception stage is either the plural IP-cores or the bridge.

18. The method as claimed in claim 13, wherein the system-on-a-chip includes:
plural IP-cores divided into plural groups according to a predetermined reference; and
an arbiter connecting the IP-cores.

19. The method as claimed in claim 18, wherein an identical code word is assigned to IP-cores in the same group, and a different code word is assigned to ones of IP-cores belonging to different groups, respectively.

20. The method as claimed in claim 18, wherein the transmission stage and the reception stage are any of the plural IP-cores.

21. The method as claimed in claim 14, further comprising determining whether the transmission stage and the reception stage are in the same group.

22. The method as claimed in claim 21, when the transmission stage and the reception stage are determined not to be in the same group, further comprising:
receiving a code word of a bridge from the arbiter;
modulating the data using the code word of the bridge and sending the modulated data; and
setting the bridge as a new transmission state.
